(19) United States
(12) Patent Application Publication
(10) Pub. No.: US 2005/0246172 A1
(43) Pub. Date: Nov. 3, 2005

(54) Acoustic model training method and system

(76) Inventor: Chao-Shih Huang, Hsichih (TW)

Correspondence Address: OSTROLENK FABER GERB & SOFFEN, 1180 AVENUE OF THE AMERICAS, NEW YORK, NY, 100368403, US

(21) Appl. No.: 11/118,701

(22) Filed: Apr. 29, 2005

(30) Foreign Application Priority Data
May 3, 2004 (TW) 093112355

(51) Int. Cl. G10L 15/06

(52) U.S. Cl. 704/243

(57) ABSTRACT

An acoustic model training method includes: (a) constructing a root speech data set, the root speech data set having a plurality of root speech data, each having a root phone; (b) constructing a Hidden Markov Model for the root speech data set; (c)constructing a sub-speech data set dependent on the root phone, the sub-speech data set having at least one sub-speech datum, the sub-speech datum having the root phone and an adjacent sub-phone; and (d) updating a parameter mean value of the sub-speech data set with reference to mean values of Hidden Markov Model parameters for the root speech data set and the sub-speech data set, and numbers of samples of speech data in the root speech data set and the sub-speech data set, respectively.

### CROSS-REFERENCE TO RELATED APPLICATION

This application claims priority of Taiwanese Application No. 093112355, filed on May 3, 2004.

### BACKGROUND OF THE INVENTION

1. Field of the Invention

The invention relates to an acoustic model training method, more particularly to an acoustic model training method, in which sub-speech data sets are used to perform adaptation training of acoustic models of a root speech data set so as to obtain acoustic models of the sub-speech data sets.

2. Description of the Related Art

Current mainstream speech recognition techniques are based on the fundamental principle of statistical model recognition. A complete speech recognition system can be roughly divided into three levels: audio signal processing, acoustic decoding, and linguistic decoding.

For phonetics, in natural speech situations, speech sounds are continuous, i.e., the demarcation between phonetic segments is not distinct. This is the so-called coarticulation phenomenon. Currently, the complicated problem of coarticulation between phonetic segments is overcome mostly by adopting context-dependent models.

Generally speaking, each mono-syllable includes at least one phone. Each phone can be divided into an initial and a final, i.e., a consonant and a vowel. Since the same phone will have different acoustic models in different sentences due to the effect of coarticulation, the number of phones in different languages varies as well. For instance, there are 40-50 phones in English, whereas there are 37 phones in Chinese. If a context-dependent model is built according to context relationship, the required number of acoustic models will be huge. For instance, the Chinese language will require about 60,000 acoustic models, whereas the English language will require about 125,000 acoustic models. Besides, the building of each model requires sufficient speech data in order to impart a certain degree of reliability to the model. In order that there are sufficient speech data for each speech model to train reliable models, parameter sharing is a usually adopted approach to speech training.

At present, a decision tree is employed to train acoustic models using relevant speech data sharing parameters. The decision tree is a method of integrating phonetics and acoustics in a top-down approach, in which all the speech data belonging to the same phone are placed at the uppermost level, and are divided into two clusters. The differences among elements in the same cluster are smaller, whereas the differences among elements in different clusters are larger. In this way, acoustically similar models can be grouped together, while dissimilar models can be separated. Iterative splitting will yield clusters that are sets of shared parameters. The models in the same cluster can share speech training data and parameters. However, the clusters are not split without restraint. If the number of speech data in a cluster is less than a threshold value, i.e., the amount of speech training data in the cluster is sparse, the models to be trained therefrom will not have robustness, thereby resulting in inaccurate training models. A current method to solve this problem is by backing-off to all the speech data in the level immediately above the cluster and using the same as the reference speech data when building the models. That is to say, using the models in the level immediately above the cluster as substitutes. For instance, if there are insufficient speech data beginning with the initial phone “aₙ” (meaning that “a” is followed by “n” speech data), the parameters of the initial phone “a” are backed-off to substitute “aₙ”. However, in actuality, the threshold value of the number of speech data in the speech data clusters is not easy to determine, and backing-off to the parameters of the speech data in the upper level offers little help in enhancing the resolution of the models.

### SUMMARY OF THE INVENTION

Therefore, the object of this invention is to provide an acoustic model training method which can effectively use available speech data to build a relatively precise acoustic model.

According to one aspect of this invention, an acoustic model training method includes:

(a) constructing a root speech data set, the root speech data set having a plurality of root speech data, each of the root speech data having a root phone;

(b) constructing a Hidden Markov Model for the root speech data set;

(c) constructing a sub-speech data set dependent on the root phone, the sub-speech data set having at least one sub-speech datum, the sub-speech datum having the root phone and a sub-phone adjacent to the root phone; and

(d) using the following equation to update a parameter mean value of the sub-speech data set:

$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$

where \overline{μᵢ} and \overline{μ_{d}} are mean values of Hidden Markov Model parameters for the root speech data set and the sub-speech data set, respectively, nᵢ and n_{d} are numbers of samples of speech data in the root speech data set and the sub-speech data set, respectively, k is a weighted value, and \overline{μ} is the updated mean value of the Hidden Markov Model parameters for the sub-speech data set.

According to another aspect of this invention, a system for implementing an acoustic model training method is loadable into a computer for constructing acoustic models corresponding to input speech data. The system has a program code recorded thereon to be read by the computer so as to cause the computer to execute the following steps:

(a) constructing a root speech data set, the root speech data set having a plurality of root speech data, each of the root speech data having a root phone;

(b) constructing a Hidden Markov Model for the root speech data set;

(c) constructing a sub-speech data set dependent on the root phone, the sub-speech data set having at least one sub-speech datum, the sub-speech datum having the root phone and a sub-phone adjacent to the root phone; and

(d) using the following equation to update a parameter mean value of the sub-speech data set:

$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$

where \overline{μᵢ} and \overline{μ_{d}} are mean values of Hidden Markov Model parameters for the root speech data set and the sub-speech data set, respectively, nᵢ and n_{d} are numbers of samples of speech data in the root speech data set and the sub-speech data set, respectively, k is a weighted value, and \overline{μ} is the updated mean value of the Hidden Markov Model parameter for the sub-speech data set.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart illustrating steps of pre-processing a speech sound and feature extraction;

FIG. 2 is a flowchart illustrating a training process using a Hidden Markov Model;

FIG. 3 is a flowchart illustrating a speech recognition process;

FIG. 4 is a schematic view illustrating states of a speech signal having 13 frames;

FIG. 5 is a schematic view illustrating a possible path of the frames and states;

FIG. 6 is a schematic view illustrating another possible path of the frames and states;

FIG. 7 is a schematic view illustrating updated states of the speech signal;

FIG. 8 illustrates a computer loaded with an embodiment of a system for implementing an acoustic model training method according to this invention;

FIG. 9 is a block diagram illustrating an acoustic model building module;

FIG. 10 is a schematic view illustrating a decision tree;

FIG. 11 is a flowchart illustrating a preferred embodiment of an acoustic model training method according to this invention; and

FIG. 12 is a schematic view illustrating parameter adaptation in the acoustic model training method according to this invention.

### DETAILED DESCRIPTION OF THE PREFERRED EMBODIMENT

Before the present invention is described in greater detail, it should be noted that the acoustic model training method according to this invention is suited for use with the language of any country or people, and that although this invention is exemplified using the English language, it should not be limited thereto

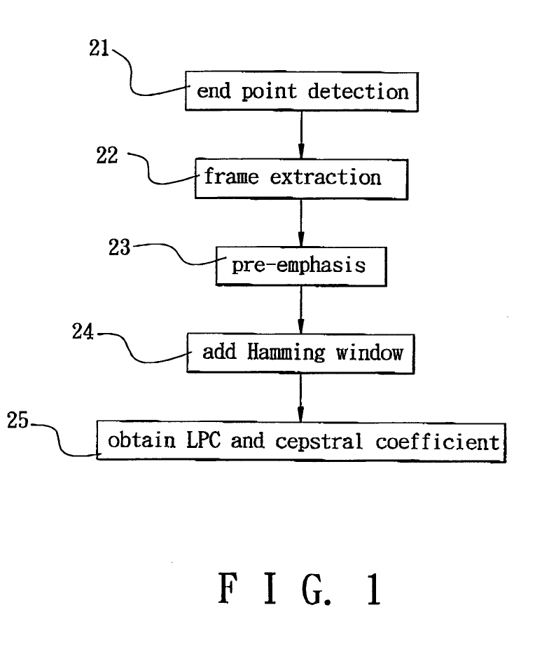

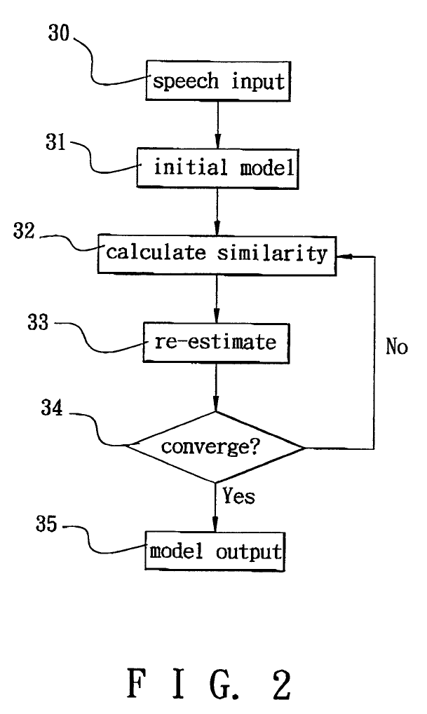

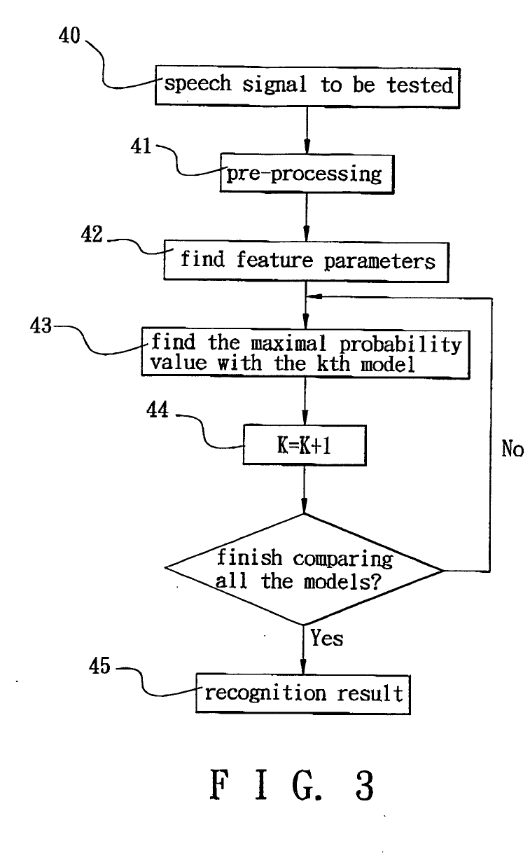

The content of automatic speech recognition (ASR) can be explained briefly in three parts: 1. Feature parameter extraction (see FIG. 1); 2. acoustic model training (see FIG. 2); and 3. recognition (see FIG. 3).

Although an original speech signal can be directly used for recognition after being digitized, the original speech signal is very rarely stored in its entirety for use as standard reference speech samples since the amount of data is voluminous, the processing time is excessively long, and the recognition efficiency is unsatisfactory. Therefore, it is necessary to perform feature extraction based on the features of the speech signal so as to obtain suitable feature parameters for purposes of comparison and recognition. Prior to feature extraction, the speech signal must be subjected to pre-processing. As shown in FIG. 1, the pre-processing includes end point detection (step 21). That is, the speech signal and a threshold value associated with background noise arc compared. There are usually some unvoiced portions before and after speech. However, these unvoiced portions are not needed, and must be removed by detecting the end point of the speech. Methods of detection that can be used include, for instance, detection and determination according to energy and zero-crossing rate (ZCR). Subsequently, step 22 is performed to extract a frame of the speech signal. When people talk, the position and shape of the vocal organs will vary with time to produce different sounds, which is known as the time-varying system. However, it was found through experimental observation that the change of a speech signal is very slow within a very short time interval, such a signal being called a piece-wise stationary signal. Therefore, when analyzing a speech signal, the speech signal has to be processed in segments, and it is supposed that the vocal system is a time-invariant system within the short time interval. The short time interval is called a frame, and the entire speech signal is segmented into a series of successive frames. The feature within each frame is stationary, and the frames can overlap in part or do not overlap at all. Thereafter, step 23 is carried out to perform pre-emphasis. As speech sound will suffer attenuation of about 6 db/oct with a rise in frequency after being uttered by the human mouth, in order to compensate for this loss, a high-pass filter is used to compensate and amplify high-frequency signal components of the speech signal in each frame. Subsequently, step 24 is carried out to multiply each frame by a Hamming window such that the spectral changes of two adjacent frames will not be excessive. That is, in order to reduce the effect of discontinuity of signals on two boundary points of the frames, each frame is multiplied by a window function of the Hamming window to lower the signals in the two frames. Finally, step 25 is carried out to obtain a linear predictive coding (LPC) and a cepstral coefficient of each frame. The feature parameters are in units of frames. A set of feature parameters can be obtained for each frame. Prior to obtaining the cepstral coefficient, the LPC must be found first. After obtaining the LPC, the LPC is converted to cepstral coefficients, because cepstral coefficients can better express the features of the speech signal than the LPC, and the feature value of the speech signal is the cepstral parameter.

After determining the feature value of the speech signal, a speech model is constructed. A left to right Hidden Markov Model (HMM) is adopted in this embodiment to simulate the process of change of the vocal tract in the oral cavity. The building of a speech sample model involves using an abstract probability model as a reference sample to describe speech features. That is, the measurement of recognized speech is not the magnitude of distortion but is the calculation of the probability generated from the model.

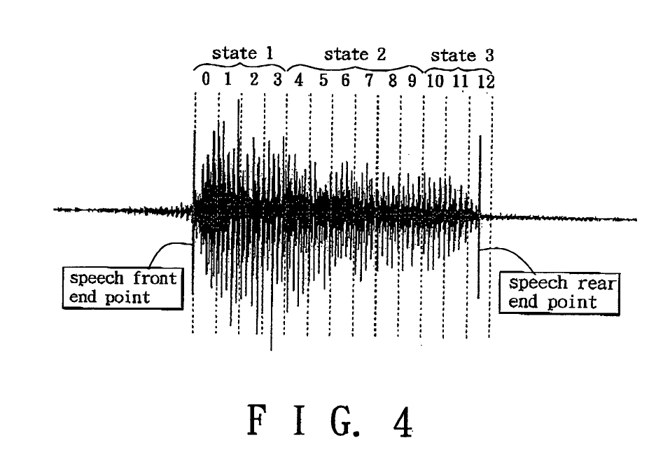

The major feature of HMM is the use of a probability density function to describe the variation of a speech signal. When a speech signal is described by states, the state of each frame is stationary locally if not transiting to a next state. A state transition probability can be used to represent the state transition or stationary process. In addition, a state observation probability can be used to represent the extent of similarity of the frames and states. With reference to FIG. 2, to illustrate, a speech signal having 13 frames (see FIG. 4) is inputted (step 30). When training a model, it is hypothesized that there are three states. At the beginning, the state to which each of the frames belongs is not known. Therefore, all the frames are allocated evenly to the states. That is, frames 0-3 are allocated to state 1, frames 4-7 are allocated to state 2, and frames 8-12 are allocated to state 3, i.e., “even distribution” (setting an initial model) (step 31) After even distribution, the frames included in each state can be known. During the aforesaid process of extracting feature parameters, each frame has a set of speech feature parameters. In the step to follow, the mean value and covariance within each state are obtained, which process is exemplified using state 1 with reference to Table 1.

TABLE 1

| State 1 | Frame (0) | Frame (1) | Frame (2) | Frame (3) |
|---|---|---|---|---|
| Feature | f₁(0, 1) | f₁(1, 1) | f₁(2, 1) | f₁(3, 1) |
| value 1 | | | | |
| Feature | f₁(0, 2) | f₁(1, 2) | f₁(2, 2) | f₁(3, 2) |
| value 2 | | | | |
| Λ | Λ | Λ | Λ | Λ |
| Feature | f₁(0, 20) | f₁(1, 20) | f₁(2, 20) | f₁(3, 20) |
| value 20 | | | | |

Each frame has 20 feature values, in which ƒ₁(n,i) is defined as the ith speech feature parameter of the nth frame in state 1, whereas ƒᵢ=(ƒ₁(i,1), ƒ₁(i,2), Λ, ƒᵢ(i,20))′ represents the vector of the speech feature parameter within the ith frame in state 1. Hence, the estimated mean value and covariance in state 1 are

$${\hat{μ}}_{1} = \frac{{\sum }_{j = 0}^{3} \tilde{{f}_{1} ( j )}}{4} \qquad and \qquad {\sum }_{1}^{\hat{}} = \frac{{\sum }_{j = 0}^{3} ( \tilde{f} - {\overline{μ}}_{1} ) {( \overline{f} - {\overline{μ}}_{1} )}^{′}}{4}$$

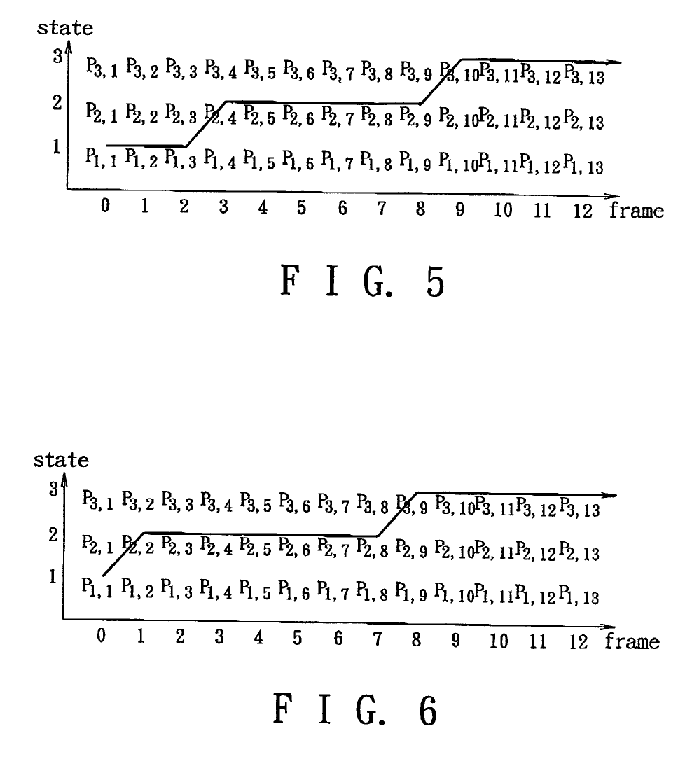

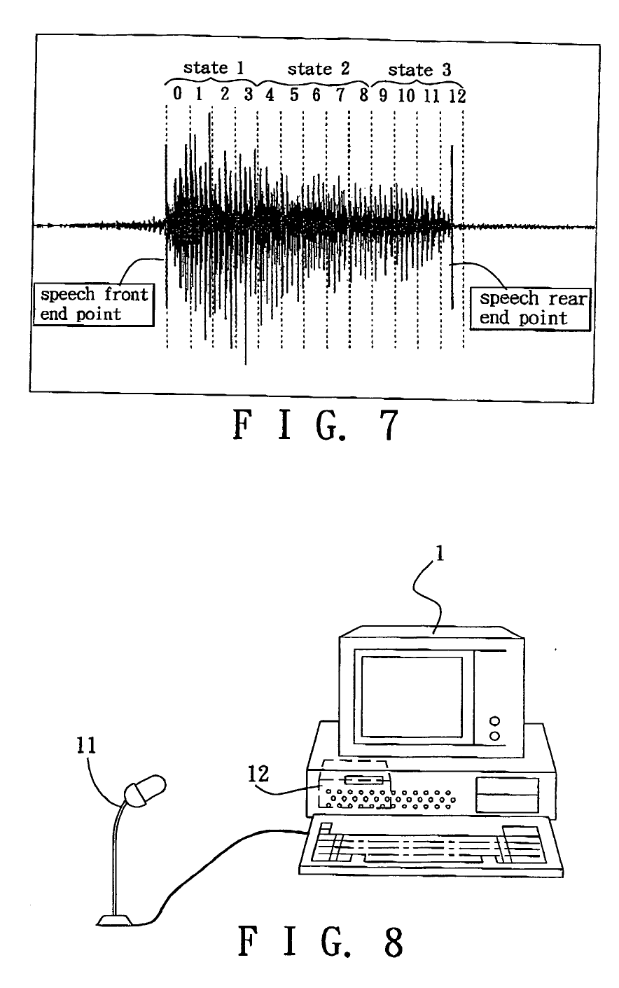

The mean value and covariance of state 2 and state 3 can be obtained in the same manner. However, model building is not completed merely by even distribution of states. Even distribution is employed to give each model an initial value. Subsequently, the extent of similarity between the frames and the states needs to be computed using, in general, a multiple variable Gaussian probability density function as follows:

$${P}_{i} ( {x}_{j} ) = {( 2 π )}^{- \frac{p}{2}} {\vert {\sum }_{I} \vert}^{- \frac{1}{2}} exp [ - \frac{1}{2} {( {x}_{j} - {μ}_{i} )}^{T} {\sum }_{i}^{- 1} ( {x}_{j} - {μ}_{i} ) ]$$

where i=1, 2, 3, representing states, and j=1, 2, Λ, N_{∫}, representing the frame number. By using P_{i,j} to represent Pᵢ(xⱼ) and by employing a multiple variable Gaussian probability density function distribution, the extent of similarity (similarity probability value) between each frame and each state can be obtained (step 32). Thus, the state to which a frame is comparatively similar can be found. Next, these probability values are used to find many paths. FIGS. 5 and 6 show two possible paths. A path that leads to the maximal total probability value of the frame and the state must be found. It is noted that states have a temporal concept. That is, state 2 must come after state 1, and state 3 must come after state 2. The obtained path must satisfy the temporal concept To find a path that satisfies the temporal concept and that leads to the maximal total probability value, the Viterbi algorithm can be used. After obtaining a new frame and state relationship using the aforesaid algorithm, the frames in the states are updated. As shown in FIG. 7, after updating, frames 0-2 belong to state 1, frames 3-8 belong to state 2, and frames 9-12 belong to state 3. When the new state and frame relationship is known, a mean value of the new states can be found. Then, by using the multiple variable Gaussian probability function, a new frame and state similarity probability value can be found. Furthermore, by using the algorithm, a new total probability value can be obtained (step 33). At this time, a decision is made as to whether or not the result proceeds to convergence (step 34). When the new total probability value is smaller than or equal to the previous total probability value, the frame and state relationship will be the output result. On the contrary, if the new total probability value is greater than the previous total probability value, path backtracking in the algorithm is used to find another new state and frame relationship. Then, the frames in the states are updated, and the mean value and covariance of the states are computed to find the frame and state similarity and to find a new total probability value. Decisions to end or recur are iterated. Recursion is stopped only when the total probability value is smaller than or equal to the previous total probability value and thereby ends the model training. When the model training ends, a speech signal can have mean values and covariance of three states. These values represent the speech data of the speech signal, i.e., the corpus model of speech samples (step 35). Conceptually speaking, the Markov model is used to compute the relationship between states and frames, and the foregoing is merely a brief description of the same. For details, reference can be made to L. R. Rabiner, B. -H. Juang, and C. -H. Lee, “An overview of automatic speech recognition”. In C. -H Lee, F. K. Song and K. K. Paliwal (Eds.), “Automatic Speech and Speaker Recognition: Advanced Topics”, Chapter 1, Kluwer Academic Publishers, 1996.

Referring to FIG. 3, after using the Markov model to train speech models so as to serve as reference samples, recognition is performed. A speech signal to be tested is inputted in step 40. Next, step 41 is executed to pre-process the speech signal to be tested, including frame extraction, pre-emphasis, etc. Step 42 is then performed to find the feature parameters of the speech signal to be tested before proceeding with step 43, in which the probability that the model that will utter the speech to be tested can be found from a kth model in the corpus. Thereafter, step 44 is carried out to finish comparing all of the models. Finally, step 45 is performed to compare the highest probability models, i.e., the recognition results.

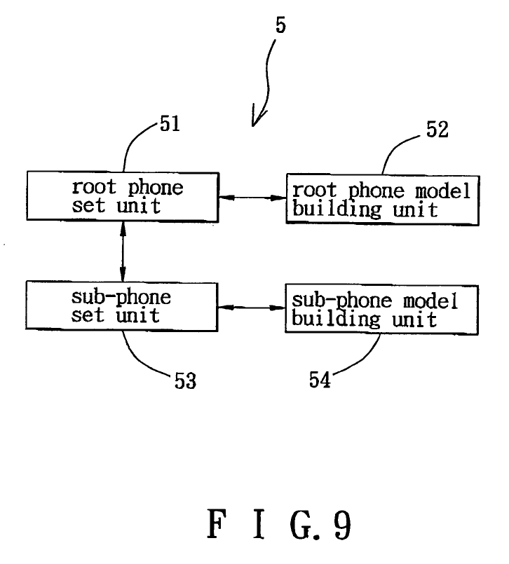

Referring to FIGS. 8 and 9, a system for implementing the acoustic model training method according to this invention can be realized in the form of a program code which is stored in a recording medium, such as an optical disk, a floppy disk, and a hard disk, in a computer 1, and which can generate an acoustic model building module 5 after being loaded into the computer 1. The computer 1 can receive and process human speech sounds. For instance, the speech sound is received through a microphone 11, and a speech processing unit 12 is used to pre-process the received speech sound so as to serve as speech data required for building the acoustic model. The pre-processing includes processes such as end point detection, frame extraction, pre-emphasis, etc. Then, feature parameters representing the speech sound are extracted for storage in a feature file.

The acoustic model building model 5 has a root phone set unit 51, a root phone model building unit 52, a sub-phone set unit 53, and a sub-phone model building unit 54.

The root phone set unit 51 pre-sets a phone as a root phone. For example, “a” is selected as a root phone. Certainly, other phones, such as “e,” “i,” “o,” and “u,” can also be selected. Feature files containing speech data of the root phone are selected from the computer 1, and “a_{n,}” “a_{m,}” and “a_{b}” (the lower-case letter following “a” represents the speech data of the letter following “a”) all belong to the set, based on which a voluminous root speech data set is constructed. The set may also be referred to as a context-independent phone set.

The root phone model building unit 52 builds an acoustic model dedicated to the speech data of the root phone set. In this embodiment, the Hidden Markov Model is used, and the model provides means values \overline{μᵢ} and \overline{μ_{d}} of “a” and “a_{n”}(or “aₘ”).

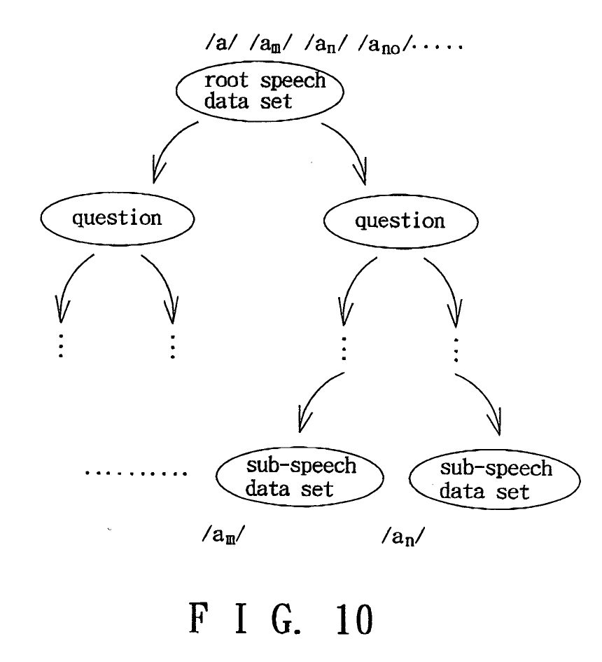

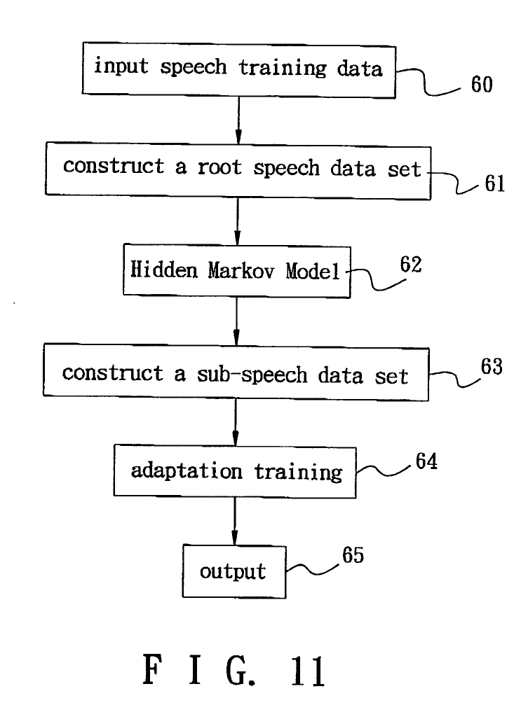

The sub-phone set unit 53 classifies sub-speech data relevant to the root phone from the root speech data set, and builds a sub-speech data set. In this embodiment, the method of classification involves using a decision tree (see FIG. 10), and adopting a right-context-dependent model (RCD). For example, aₙ (or aₘ) is selected as the sub-speech set, and may contain speech data like aₙ, aₙᵢₛₒ, aₙₒ, etc.

The sub-phone model building unit 54 updates the mean values (numerical value) of the sub-phones according to the following equation:

$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$

where \overline{μᵢ} and \overline{μ_{d}} are the mean values of the HMM parameters of the root speech data set and the sub-speech data, respectively, nᵢ and n_{d} are the numbers of speech data samples contained in the root speech data set and the sub-speech data set, respectively, k is the weighted value, and \overline{μ} is the mean value of the HMM parameter of the updated sub-speech data set.

Referring to FIG. 11, the acoustic model training method according to this invention includes the following steps:

Initially, step 60 is performed to input speech training data.

Subsequently, step 61 is performed, in which the root phone set unit 51 pre-sets a phone as a root phone, selects speech data having feature files of the root phone from the computer 1, and constructs a root speech data set. The invention is exemplified herein utilizing the initial phone “a” as the selected root phone, and using 2000 samples.

Then, step 62 is carried out, in which the root phone model building unit 52 builds an acoustic model dedicated to the root speech data set using HMM. The acoustic model provides the means values \overline{μᵢ} and \overline{μ_{d}} (feature parameters) of the speech data signals.

Thereafter, step 63 is performed, in which, after the root phone model building unit 52 has built the acoustic model for the root speech data set, the sub-phone set unit 53 classifies sub-speech data relevant to the root phone from the root speech data set, and constructs a sub-speech data set. In this embodiment, the sub-speech data are those with a selected initial phone “a_{n,}” and the number of samples is 15.

Then, step 64 is performed, in which the sub-phone model building unit 54 utilizes the speech data in the sub-speech data set for model adaptation training of the acoustic models of the root speech data set. The adaptation training rule is as follows:

$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$

After substituting the actual numbers thereinto:

$$\overline{μ} = \frac{15}{2000 k + 15} {\overline{μ}}_{d} + \frac{2000 k}{2000 k + 15} {\overline{μ}}_{i}$$

It is particularly noted that k is a weighted value, which is set depending on actual experimental requirements. It can be seen from the above equation that the updated mean value of the acoustic models of the root speech data set is between \overline{μᵢ} and \overline{μ_{d}}. Besides, the lesser the number of n_{d} samples, the closer will be the updated value to \overline{μᵢ}. On the other hand, the greater the number of n_{d} samples, the closer will be the updated value to \overline{μ_{d}}.

Finally, step 64 is performed to output the updated value.

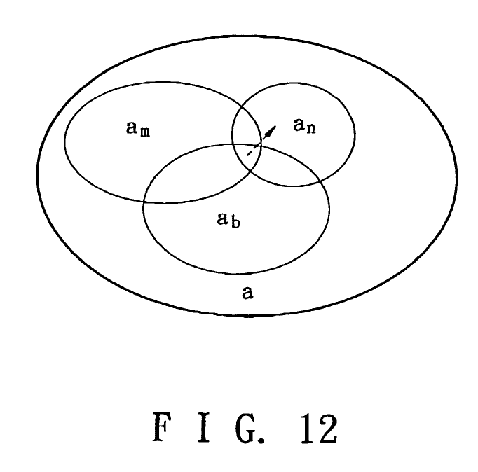

With further reference to FIG. 12, when context-dependent speech data samples are sparse (less than the threshold value, which is often set as 30), in general, the process will back-off to the parameters of the context-independent phone model. That is, the context-dependent parameters are not adopted, and the context-independent parameters are adopted instead. However, according to the training rule of this invention, there is no need to set any threshold value, and there is no need to abandon speech data with a small number of samples. Instead, the context-independent parameters are used as a basis for adaptation to context-dependent parameters so that the parameters are substantially between context-independent and context-dependent. Thus, this invention provides a better statistical estimation rule, and will not suffer from the problem of insufficient speech data samples which may result in inaccuracy of the models.

In summary, the acoustic model training method of this invention does not employ the backing-off rule which is generally applied in the prior art when making determinations using a decision tree. This invention provides a method of adaptive training of acoustic models of a root speech data set using a method different from the conventionally used Hidden Markov Model to calculate the mean values of the parameters when building acoustic models of sub-speech data sets, so as to effectively use all the speech data in the sub-speech data sets to build the acoustic models of the sub-speech data sets. Thus, this invention provides both facility and robustness, and can positively achieve the stated object.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. An acoustic model training method, comprising:
(a) constructing a root speech data set, the root speech data set having a plurality of root speech data, each of said root speech data having a root phone;
(b) constructing a Hidden Markov Model for the root speech data set;
(c) constructing a sub-speech data set dependent on the root phone, the sub-speech data set having at least one sub-speech datum, the sub-speech datum having the root phone and a sub-phone adjacent to the root phone; and
(d) using the following equation to update a parameter mean value of the sub-speech data set:
$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$
where \overline{μᵢ} and \overline{μ_{d}} are mean values of Hidden Markov Model parameters for the root speech data set and the sub-speech data set, respectively, nᵢ and n_{d} are numbers of samples of speech data in the root speech data set and the sub-speech data set, respectively, k is a weighted value, and \overline{μ} is the updated mean value of the Hidden Markov Model parameter for the sub-speech data set.

2. The acoustic model training method as claimed in claim 1, wherein the parameter is a cepstral parameter.

3. A system for implementing an acoustic model training method, said system being loadable into a computer for constructing acoustic models corresponding to input speech data, said system having a program code recorded thereon to be read by the computer so as to cause the computer to execute the following steps:
(a) constructing a root speech data set, the root speech data set having a plurality of root speech data, each of said root speech data having a root phone;
(b) constructing a Hidden Markov Model for the root speech data set;
(c) constructing a sub-speech data set dependent on the root phone, the sub-speech data set having at least one sub-speech datum, the sub-speech datum having the root phone and a sub-phone adjacent to the root phone; and
(d) using the following equation to update a parameter mean value of the sub-speech data set:
$$\overline{μ} = \frac{{n}_{d}}{k {n}_{i} + {n}_{d}} {\overline{μ}}_{d} + \frac{k {n}_{i}}{k {n}_{i} + {n}_{d}} {\overline{μ}}_{i}$$
where \overline{μᵢ} and \overline{μ_{d}} are mean values of Hidden Markov Model parameters for the root speech data set and the sub-speech data set, respectively, nᵢ and n_{d} are numbers of samples of speech data in the root speech data set and the sub-speech data set, respectively, k is a weighted value, and \overline{μ} is the updated mean value of the Hidden Markov Model parameter for the sub-speech data set.

4. The system as claimed in claim 3, wherein the parameter is a cepstral parameter.
